(19) United States
(12) Patent Application Publication
(10) Pub. No.: US 2002/0095337 A1
(43) Pub. Date: Jul. 18, 2002

(54) System and method for providing incentives to customers over a computer network

(76) Inventors: Adrian Velthuis, Baltimore, MD (US); Aleck Schleider, Baltimore, MD (US)

Correspondence Address: Finnegan, Henderson, Farabow,, Garrett & Dunner, L.L.P., 1300 I Street, N.W., Washington, DC, 20005-3315, US

(21) Appl. No.: 09/989,448

(22) Filed: Nov. 21, 2001

Related U.S. Application Data
(60) Provisional application No. 60/252,423, filed on Nov. 22, 2000.

(51) Int. Cl. G06F 17/60

(52) U.S. Cl. 705/14; 705/26

(57) ABSTRACT

A method is described for providing purchasing incentives to consumers, comprising transmitting a prompt for information from a main computer to a personal computer over a computer network, said prompt including incentive data such as coupon information, transmitting said information from said personal computer to said main computer over said computer network in response to said prompt, said information including a wireless telephone number; transmitting said incentive data from said main computer to a wireless device designated by said wireless telephone, storing said incentive data in said wireless device; and displaying said incentive data to a retailer to redeem the incentive, such as a coupon.

### RELATED APPLICATIONS

This application claims priority in U.S. Provisional Patent Application No. 60/252,423, entitled “A System and Method for Providing Incentives to Customers over a Computer Network,” filed Nov. 22, 2000.

### BACKGROUND OF THE INVENTION

1. Field of the Invention

The invention relates generally to computer systems and more particularly, to a system and method for distributing incentives via a computer network.

2. Description of Related Art

This invention relates generally to systems for providing incentives to customers to shop in retail stores or restaurants and, more particularly, to systems for delivering customer incentives and other shopping aids via a computer network. Various approaches have been widely used to deliver purchasing incentives, usually in the form of printed discount coupons, to customers of retail stores or restaurants. These purchasing incentives or coupons have been typically distributed to customers randomly by mail or inclusion in newspapers, or sometimes in a more demographically focused manner, such as to existing customers in hopes of generating repeat business. Coupons have also been distributed to customers in retail stores or restaurants, either from kiosks or at the checkout stand in response to the customer's purchase.

Now, an increasing number of retail store customers also own personal computers and many of these customers have access to computer network services or internet service providers (ISPs) that provide connections to the Internet and the World Wide Web (WWW). The Internet and the WWW are also becoming increasingly accessible to people through wireless devices like wireless telephones and personal digital assistants (PDAs), especially as other consumer electronic devices begin to merge with personal computers as Internet appliances. Although some companies' computer sites connected to the WWW have begun to offer “online” shopping services, and some services have proposed to deliver discount coupons through a computer network, the full potential of online delivery of incentives has not been realized prior to the present invention.

### SUMMARY OF THE INVENTION

The method of the invention comprises a sequence of steps performed at a central site in cooperation with a communication device at a customer site. The steps include logging in a remotely-located customer using identity data transmitted by the customer over a communication network; transmitting to the registered customer a plurality of incentive offers, the incentive offers being exercisable in the customer's geographic region; and then receiving incentive offer selection data from the customer over the communication network, the offer selection data including the customer's wireless telephone number or other identifying information. In response to the customer selection data, the method performs the steps of generating a purchasing incentive containing an identification of the customer-requested coupon and the retailer's authorization code; and transmitting the identification of the coupon and the authorization code to the customer's wireless device or computer printer for immediate storage and/or subsequent display to a particular retailer. Alternatively, a retailer may choose not to have an authorization code. For security reasons, the transmitted incentive may be encoded with the identity of the customer or provide some other encryption means to restrict the use of the incentive by the intended recipient.

In accordance with the purposes of the present invention, as embodied and broadly described, the invention provides a method for coupon delivery to a consumer through a computer network. This coupon delivery can occur either in printable or electronic form. In printable form, consumers respond to a website banner advertisement by “clicking” on the advertisement. This action causes the web browser to launch a window containing the advertising retailer's web page, along with a print dialog box window that directs the consumer to print a coupon for the retailer's business. The consumer can then bring this coupon to the retail location and redeem the coupon in accordance with the advertisement.

In another embodiment, the invention provides a method for coupon delivery to a consumer's wireless device, such as a PDA or wireless telephone, via a computer network. This coupon delivery method involves the consumer viewing a website with a banner advertisement or a retailer's website. Contained in the advertisement is a prompt for the user to enter a wireless telephone number or identification code associated with a wireless communication device. Upon entering this information, the ad serving system delivers the promotional information (coupon) to the consumer's wireless device. The consumer can then visit the retail location and show the retailer the promotional information (coupon) displayed on the wireless device in order to redeem the coupon.

The foregoing has outlined some of the more pertinent aspects and features of the present invention. These aspects should be construed to be merely illustrative of some of the more prominent features and applications of the invention. Many other beneficial results can be attained by applying the disclosed invention in a different manner or modifying the invention as will be described. Accordingly, other objects and a fuller understanding of the invention may be had by referring to the following Detailed Description.

### BRIEF DESCRIPTION OF THE DRAWINGS

In the drawings:

FIG. 1 is a diagram illustrating the operation of the coupon program in accordance with the present system;

FIG. 2 is a block diagram illustrating the Ad Server;

FIG. 3 is a block diagram illustrating a typical Web Server that can display an advertisement to a potential customer;

FIG. 4 is a detailed flow diagram of the steps performed by one embodiment of the present invention to deliver coupons to customers; and

FIG. 5 is a detailed flow diagram of the steps performed by a Web Server when a customer responds to a displayed advertisement, according to one embodiment of the present invention.

### DETAILED DESCRIPTION OF THE INVENTION

In the following detailed description of the preferred embodiments, reference is made to the accompanying drawings that form a part thereof, and in which is shown by way of illustration a specific embodiment by which the invention may be practiced. This embodiment is described in sufficient detail to enable those skilled in the art to practice the invention and it is to be understood that other embodiments may be utilized and that structural changes may be made without departing from the scope of the present invention. The following detailed description is, therefore, not to be taken in a limited sense.

In first addressing the nomenclature used in this specification, the detailed description that follows is represented largely in terms of processes and symbolic representations of operations performed by conventional computer components, including a central processing unit (CPU), memory and storage devices for the CPU, and complex display devices. These operations include the manipulation of data bits by the CPU, and the maintenance of these bits within data structures resides in one or more of the memory and/or storage devices. Such data structures impose a physical organization upon the collection of data bits stored within computer memory and represent specific electrical and/or magnetic elements. These symbolic representations are the means used by those skilled in the art of computer programming, computer construction, and otherwise software engineering, to most effectively convey the teachings and discoveries to others skilled in the art.

For the purposes of this discussion, a process is generally conceived to be a sequence of computer-executed steps leading to a desired result. These steps generally require physical manipulations of physical quantities. Usually, though not necessarily, these quantities take the form of electrical, magnetic, or optical signals capable of being stored, transferred, combined, compared, or otherwise manipulated. It is conventional for those skilled in the art to refer to these signals as bits, bytes, values, elements, packets, symbols, characters, terms, objects, numbers, records, files, or the like. It should be kept in mind, however, that these and similar terms should be associated with appropriate physical quantities for computer operations, and that these terms are merely conventional labels applied to physical quantities that exist within and during the operation of any number of computers.

It should also be understood that data manipulations within a computer are often referred to in such terms as adding, comparing, moving, transmitting, etc., which are often associated with manual operations performed by a human operator. It must be understood that no such involvement of a human operator is necessary or even desirable in the present invention. The operations described herein are machine operations performed in conjunction with a human operator or user who interacts with the computer. The machines used for performing the operation of the present invention include general-purpose digital computers or other similar computing devices.

In addition, it should be understood that the programs, processes, methods, etc., described herein are not related or limited to any particular computer or apparatus. Rather, various types of general-purpose machines may be used with programs constructed in accordance with the teachings described herein. Similarly, it may prove advantageous to construct specialized apparatuses to perform the method steps described herein by way of dedicated computer systems with hard-wired logic or programs stored in nonvolatile, volatile, or cached memory, such as read-only memory (ROM) and random-access memory (RAM).

The operating environment in which the present invention is used encompasses general distributed computing systems wherein general-purpose computers, work stations, or personal computers are connected via communication links of various types. In a client-server arrangement, for example, programs and data (many in the form of objects) are made available by various members of the system.

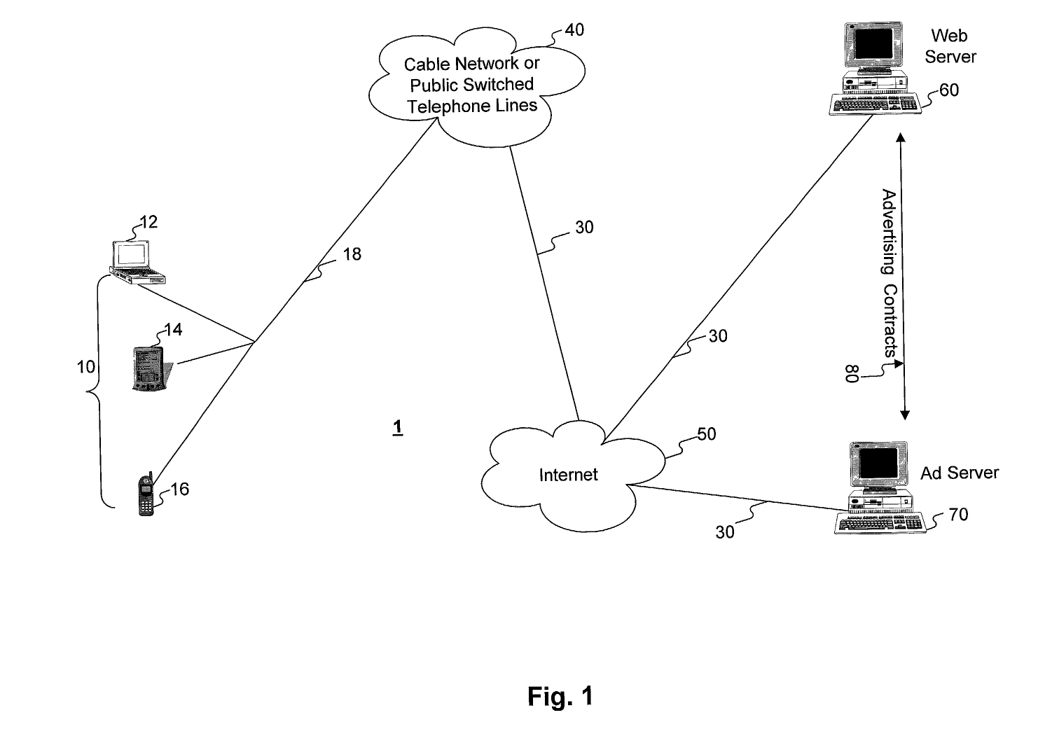

Referring now to the drawings, the present invention will be described. FIG. 1 is an overview of a computer network adapted to provide redeemable incentives to a consumer via a plurality of wireless or wired computer devices. Network 1 includes user devices 10, a cable network or public-switched telephone network (PSTN) 40, Internet 50, Web Server 60, and Ad Server 70. User devices 10 further comprise a personal computer 12, a PDA 14, and a wireless device 16. Wireless device 16 may be a simple pager that alerts a user of incoming messages, an enhanced pager with information transmission and retrieval capabilities, cellular telephones operating on one or more analog and digital systems, wireless email devices, or any other handheld device capable of accessing a network over a wireless communications medium. Web Server 60 hosts web pages from publishers of general content, retail stores, restaurants, and other businesses. Ad Server 70 comprises a computer or other data server that provides advertising content and otherwise communicates with Web Server 60 through Internet 50 to facilitate the transmission and reception of advertising incentive information to customers. Advertising contracts 80, as shown in FIG. 1, may be transacted between Web Server 60 and Ad Server 70. In this way, the advertising content maintained on Web Server 60 can be monitored and updated as necessary, based on customer web page requests. Ad Contracts 80 facilitated between Web Server 60 and Ad Server 70 are obtained by purchasing space for banner ads on company websites where either a set amount of space is purchased at a set price, or where companies agree to receive a revenue share for the banner ads they choose to display on their websites. User devices 10 are linked to network 1 via a wireless or wired link 18. Link 18 is coupled to Internet 50 via a cable network or PSTN 40. In one embodiment, user devices 10 are connected to link 18, Internet 50, and then to Web Server 60. Web Server 60 and Ad Server 70 are coupled directly to Internet 50 via a network connection 30.

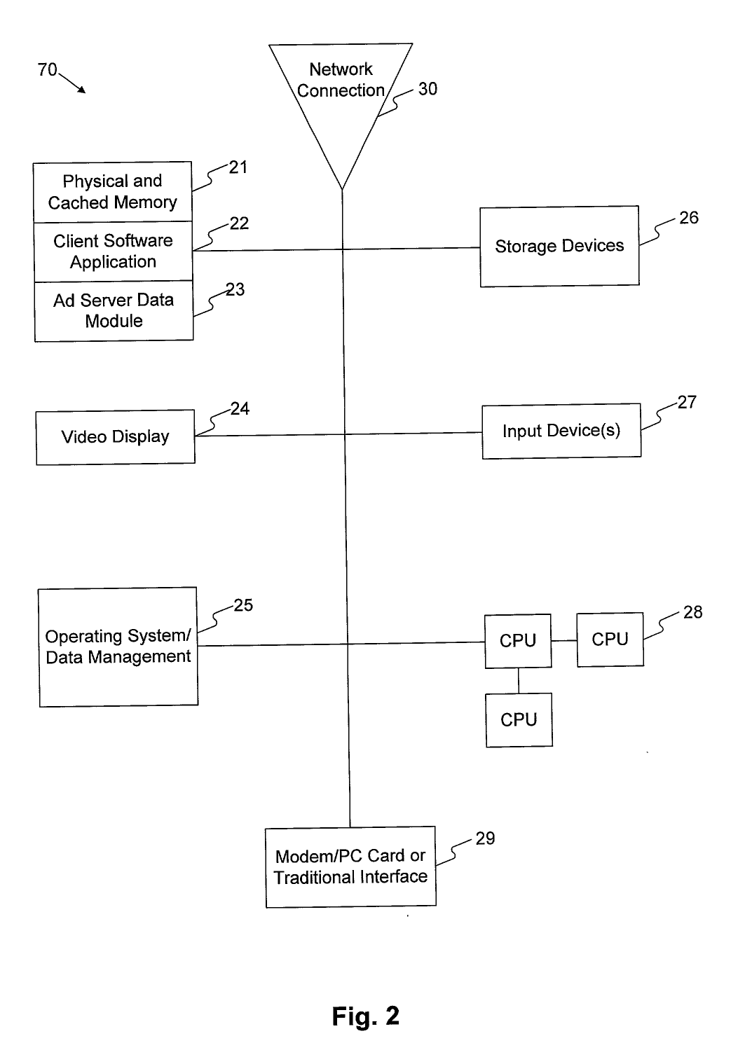

Referring now to FIG. 2, there is shown a more detailed block diagram of Ad Server 70 as shown in FIG. 1. As shown, Ad Server 70 contains physical and cached memory 21, a client software application 22, an Ad Server data module 23, a video display 24, an operating system and/or data management software system 25, storage devices 26, input device(s) 27, one or more CPUs 28 which can be connected together for parallel processing, and a modem/PC card or other network interface 29.

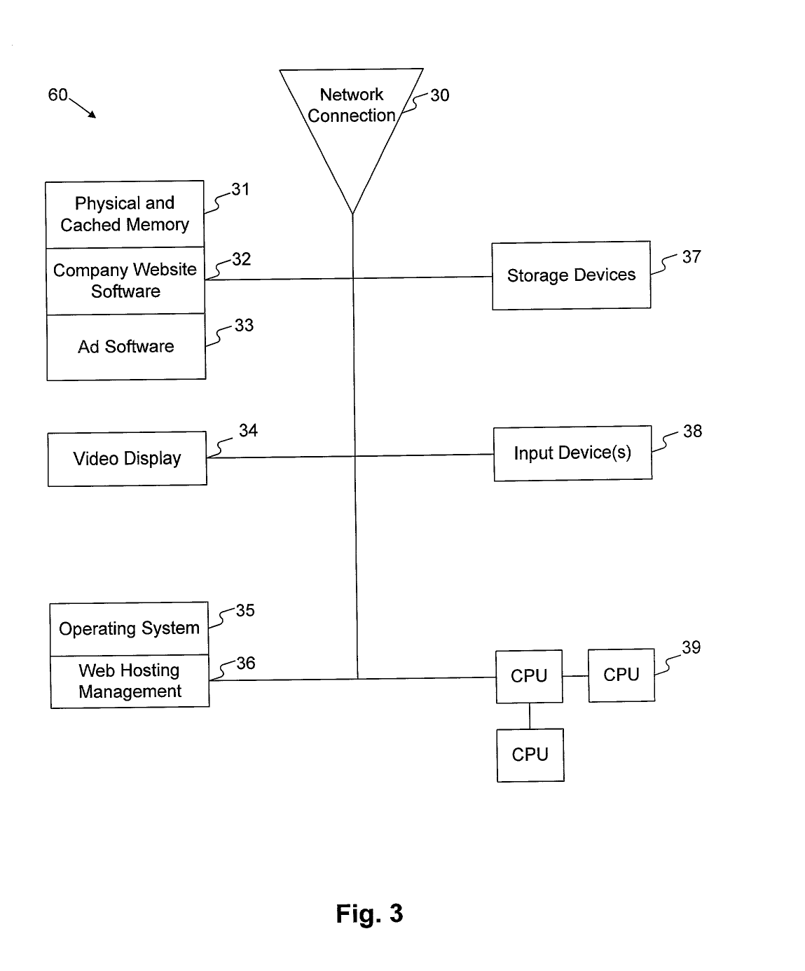

FIG. 3 shows a more detailed block diagram of Web Server 60 as shown in FIG. 1. Web Server 60 contains physical and cached memory 31, company website software 32, advertisement software 33, a video display 34, an operating system 35, a web hosting management software 36, storage devices 37, input device(s) 38, and one or more CPUs 39 that can be connected together for parallel processing.

The advertising content typically provided on web pages can be represented by what are commonly called “banner ads,” which are usually web-based banner images, typically 468×60 pixels of screen space on a personal computer video display. Ad Server 70 delivers these banner ads to any number of websites hosted on Web Server 60.

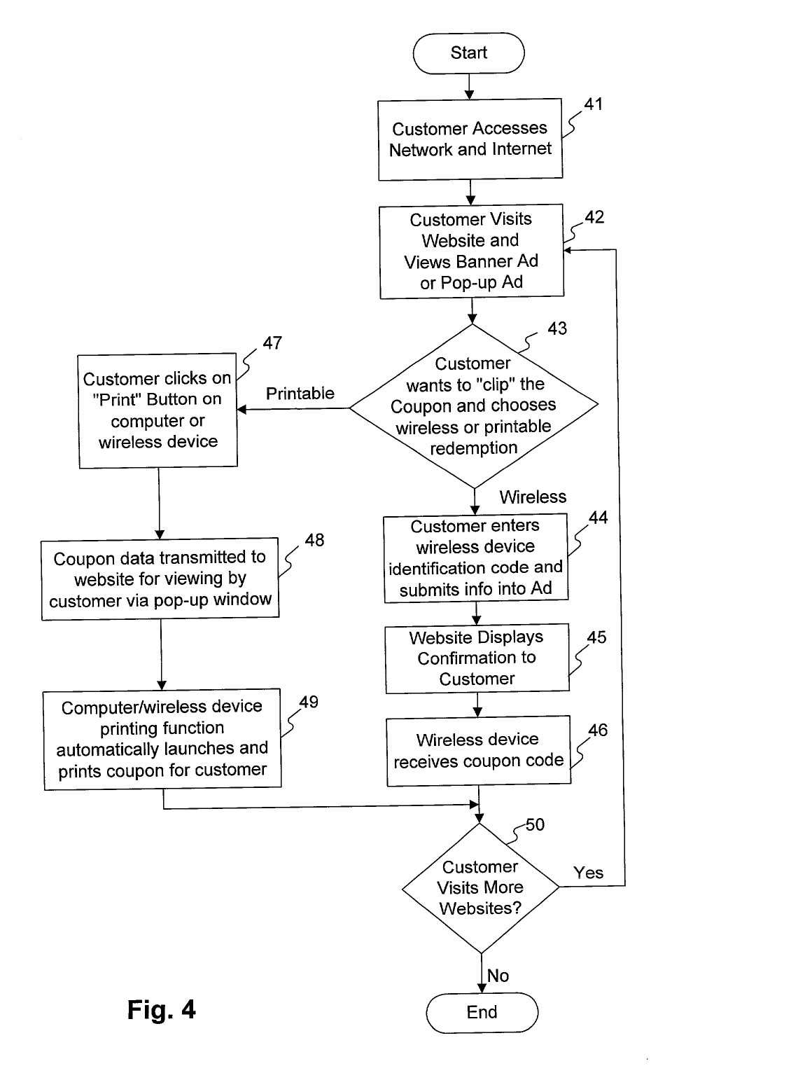

FIG. 4 shows a detailed flow diagram of the steps performed by one embodiment of the present invention to deliver coupons to customers. The process begins in step 41 when the customer accesses network 1 and Internet 50 utilizing any form of web browsing or communications software. Once connected to Internet 50, the customer visits a website and views a banner ad (step 42) described above, or a “pop-up” ad window that automatically launches as the web page loads. The banner ad may contain incentives prompting the customer to acquire a coupon redeemable at an advertiser's retail store or restaurant. Such incentives may contain a blank form space for the customer to input a wireless device identification code, such as a wireless telephone number, to provide information for transmittal of a coupon to said wireless device.

When the customer wants to “clip” the coupon, there is a choice of wireless or printable redemption means (step 43). If the customer chooses wireless redemption, the customer enters the wireless identification code and submits the information into the banner ad (step 44). The website then displays a confirmation to the customer (step 45) and the wireless device receives the coupon code (step 46). The customer can then elect to visit more websites (step 50), or disconnect from Internet 50.

If the customer chooses printable redemption at step 43, the customer clicks on the “print” button on their computer or wireless device (step 47), and the coupon data is transmitted to the website for viewing by the customer via a pop-up window (step 48). The computer or wireless device's printing function automatically launches and prints the coupon for the customer (step 49). The customer can then elect to visit more websites (step 50), or disconnect from Internet 50.

The format of the coupon data can be modified so that it conforms to a specific wireless device company's specifications or the customer's wireless device limitations. Coupon data sent to the customer from Ad Server 70 may need to be formatted to allow transmission to a variety of wireless devices. For example, if the advertising messages are sent to a wireless telephone, they could be formatted as a text message containing a coupon code for redemption at a retail store or restaurant. Also, the coupon data can be sent as an email message, or voice message for certain wireless telephones, pagers or PDAs. Additionally, barcode or other unique identifier information may be inserted with the coupon data.

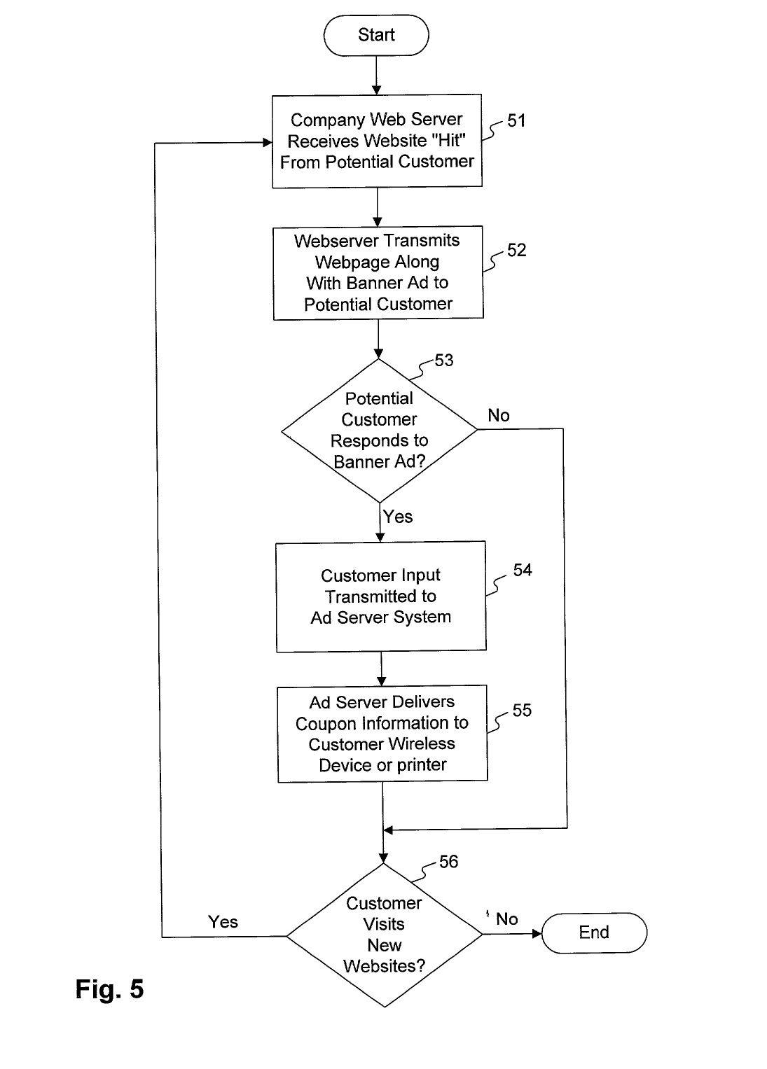

FIG. 5 is a detailed flow diagram of the steps performed by Web Server 60 when a customer responds to a displayed advertisement, according to one embodiment of the present invention. The process beings when a company web server receives a “hit” from a potential customer as they access the website (step 51). When Web Server 60 receives a hit, it may also tally statistics on how pervasive a particular ad is among many different websites. Web Server 60 transmits the web page data along with a banner ad to the potential customer through Internet 50 (step 52). The potential customer is then presented with a choice (step 53) of whether to respond to the banner ad. The potential customer's response can be accomplished by inputting contact information requested by the advertiser directly into the banner ad window, or by simply clicking on the banner ad window itself. A customer, may, for example, input a wireless telephone number or other network address. This contact data is transmitted to Ad Server 70 via http or other network transfer protocol. Ad Server 70 records and processes the data, upon which the customer-submitted data is parsed for the proper format. It then queries a database of wireless carrier telephone numbers to identify the customer's wireless carrier, grabs the proper address format to reach the identified carrier, assembles the promotional message with the address information (to:/from:/subject:), and delivers the assembled package of data via TCP/IP or IS41, for example, (or any other communication protocols) to the potential customer.

Ad Server 70 identifies the user's wireless carrier by comparing elements of the customer's wireless telephone number, such as area code (NPA) and local exchange (NXX) to a database of public and private telephone number records that may be stored on Ad Server 70. The database of delivery addresses associated with those wireless carriers is maintained to prevent potential customers from downloading more than an allocated number of coupons for a specific retail store or restaurant in a specified time period, for example.

If the potential customer opts to respond to the banner ad in step 53, processing flows to step 54, at which time the customer input is transmitted to Ad Server 70. Ad Server 70 then delivers the coupon information to the potential customer's wireless device or printer (step 55), as indicated above. Next, Ad Server 70 transmits a new banner ad to Web Server 60, and transmits updated data to data management software 25 to keep track of coupons redeemed by customers. If the potential customer opts not to respond to the banner ad at step 53, processing flows from step 53 to step 56. With either choice, the potential customer can then visit other websites and repeat the process (step 56) or disconnect from Internet 50.

From the foregoing description, it will be appreciated that the present invention provides an efficient system and method for the distribution, via a computer network, of incentives and other related shopping aids useful to retail customers. The present invention has been described in relation to particular embodiments, which are intended in all respects to be illustrative rather than restrictive. Those skilled in the art will appreciate that many different combinations of hardware will be suitable for practicing the present invention. Many commercially available substitutes, each having somewhat different cost and performance characteristics, exist for each of the components described above.

Although aspects of the present invention are described as being stored in memory, one skilled in the art will appreciate that these aspects can also be stored on or read from other types of computer-readable media, including secondary storage devices, like hard disks, floppy disks, Zip® disks, tape-backup units (TBUs), CD-ROMs, CD-RWs, DVD-ROMs, DVD-RWs; carrier waves through the Internet, or other forms of RAM or ROM. Similarly, the method of the present invention may conveniently be implemented in program modules that are based upon the flow charts presented herein. No particular programming language has been indicated for performing the various procedures described above, because it is considered that the operations, steps, and procedures described and illustrated in the accompanying drawings are sufficiently disclosed to permit one of ordinary skill in the art to practice the present invention. Moreover, there are many computers and operating systems, which may be used in practicing the present invention, and therefore, no detailed computer program could be provided which would be applicable to these many different systems. Each user of a particular computer will be aware of the language and tools which are most useful for that user's needs and purposes.

Alternative embodiments will become apparent to those skilled in the art to which the present invention pertains without departing from its spirit or scope. Accordingly, the scope of the present invention is defined by the appended claims rather than the foregoing description.

We claim:

1. A method for providing purchasing incentives to customers, comprising:
transmitting a coupon from a first computer to a second computer;
displaying the coupon on the second computer; and
showing the displayed coupon to a retailer to redeem the coupon.

2. The method of claim 1, wherein the transmitting step further includes transmitting a coupon from the first computer to the second computer, provided the second computer has received less than a predetermined number of coupons.

3. The method of claim 1, where the displaying step further comprises displaying a subset of information associated with the coupon to accommodate display characteristics of the second computer.

4. A method for providing purchasing incentives to customers, comprising:
transmitting an advertisement from a first computer to a second computer, said advertisement offering a purchasing incentive to a customer;
inputting information into the second computer, wherein the inputted information directs a third computer to transmit a coupon associated with the advertisement to a computer associated with the inputted information;
transmitting the inputted information to the third computer; and
transmitting the coupon to the computer associated with the inputted information.

5. The method of claim 4, wherein the step of transmitting an advertisement from a first computer to a second computer, further comprises the step of transmitting a web page depicting the advertisement from the first computer to the second computer.

6. The method of claim 4, wherein the step of transmitting the coupon to the computer associated with the inputted information, further comprises transmitting the coupon to a printer.

7. The method of claim 4, wherein the step of transmitting the coupon to the computer associated with the inputted information, further comprises transmitting the coupon to a display.

8. The method of claim 7, wherein the display is associated with a wireless telephone.

9. A computer-readable medium containing instructions for controlling a computer to perform a method for providing incentives to customers, the method comprising:
transmitting a coupon from a first computer to a second computer;
displaying the coupon on the second computer; and
showing the displayed coupon to a retailer to redeem the coupon.

10. The computer-readable medium of claim 9, wherein the transmitting step further includes transmitting a coupon from the first computer to the second computer, provided the second computer has received less than a predetermined number of coupons.

11. The computer-readable medium of claim 1, where the displaying step further comprises displaying a subset of information associated with the coupon to accommodate display characteristics of the second computer.
